(19) United States
(12) Patent Application Publication
(10) Pub. No.: US 2025/0335246 A1
(43) Pub. Date: Oct. 30, 2025

(54) OPTIMIZING SERVER AND DATA CENTER COOLING USING INTELLIGENT WORKLOAD SCHEDULING

(71) Applicant: Dell Products L.P., Round Rock, TX (US)

(72) Inventors: Xuebin He, Westwood, MA (US); Ahmed Elsayed Elshafey, New Cairo (EG); Amy N. Seibel, Newton, MA (US)

(21) Appl. No.: 18/647,367

(22) Filed: Apr. 26, 2024

(51) Int. Cl. G06F 9/48; G06F 1/20; G06F 9/50

(52) U.S. Cl. CPC G06F 9/4893; G06F 1/206; G06F 9/505; G06F 9/5094

(57) ABSTRACT

Thermal output aware workload placement is disclosed. When a scheduler receives a workload to be deployed in computing resources such as a pool of servers, thermal data that may include fan related data and power consumption data is used to select one of the servers for the workload. The thermal data is used to select the server that reduces or minimizes the thermal output of the server and/or the computing resources.

### TECHNOLOGICAL FIELD OF THE DISCLOSURE

Embodiments disclosed herein generally relate to data center operations including thermal management and controls. More particularly, at least some embodiments relate to systems, hardware, software, computer-readable media, and methods for scheduling workloads in a data center to reduce or minimize thermal outputs.

### BACKGROUND

Data centers generally refer to buildings or facilities that house computing infrastructure such as storage systems, server computers, routers, and other hardware. Data centers are often referred to as the cloud and are often accessed over the Internet. Data centers provide the computing resources needed to store data and run applications of multiple types for a large variety of clients.

However, operating a data center is not without cost. A data center consumes a significant amount of energy to power the computing equipment. A significant portion of the cost is related to cooling requirements. More specifically, running computing equipment generates heat. The generation of heat, however, can increase both cooling and power requirements and impacts the operation of computing systems in adverse manners.

For example, excessive heat lowers the electrical resistance of compute circuits. As a result, operating the compute circuits requires more current. In other words, hotter circuits are less efficient, more power hungry, and less environmentally friendly. Consequently, the energy costs associated with operating computing resources and the cost of providing cooling can be significant. The environmental impact of operating a datacenter can be significant in terms at least in terms of energy (power) and cooling requirements and thermal output.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a central processing unit (CPU) fan curve;

FIG. 2 discloses aspects of scheduling and executing workloads in the context of thermal management;

FIG. 3 discloses aspects of a method for controlling thermal output of a server or of computing resources;

FIG. 4 illustrates an example of selecting a server for scheduling a workload in a thermally aware manner; and

FIG. 5 discloses aspects of a computing device, system, or entity.

### DETAILED DESCRIPTION OF SOME EXAMPLE EMBODIMENTS

Embodiments disclosed herein generally relate to thermal management in computing environments such as data centers. More particularly, at least some embodiments relate to systems, hardware, software, computer-readable media, and methods for minimizing or reducing a thermal output of a data center.

Embodiments of the invention are discussed in the context of data centers. However, embodiments of the invention may be applied in other computing environments including, but not limited to, cloud computing environments, edge computing environments, or the like. Embodiments of the invention more specifically relate to scheduling workloads in a computing environment such as a data center in a manner that is thermally aware. Workloads can be scheduled to reduce the thermal output that would otherwise occur.

Temperature management and the associated energy costs are among the biggest expenses for data centers and represent an environmental challenge. Stated differently, executing workloads in a data center may be associated with a thermal load that can impact the execution of workload and impact thermal efficiencies. Embodiments of the invention relate to scheduling (e.g., placing and executing) workloads in a manner that reduces or minimizes the thermal output of the data center. In other words, embodiments of the invention are configured to schedule workloads in a manner the reduces or minimizes the impact of the workload on the thermal load. Embodiments of the invention relate to managing the thermal load while satisfying workload execution requirements, client requirements and/or other requirements.

Workloads can be scheduled to a suitable server to reduce the overall thermal load. In one example, the thermal output or thermal load of a machine (e.g., a server or a computing device) may be reflected in its current fan load and/or power consumption.

Computer fan speeds are generally measured in two units. Revolutions per minute (RPM) measures the number of revolutions per minute for a fan and is an example of a first unit. Pulse width modulation (PWM) is an example of fan load or duty cycle and is an example of a second unit. For example, a fan rated at 20000 RPM maximum load that is currently operating at 8000 RPM is at 40% PWM. This measurement also represents a current electrical load of the fan compared to a maximum electrical load of the fan.

The speed or PWM of a fan is often controlled using set points and a temperature. For example, a fan operating at 8000 RPM at a current temperature of 27 C may switch to 12000 RPM when a temperature of 28 C is detected. Thus, the RPM or PWM is indicative of a thermal load and current temperatures. Embodiments of the invention may use fan speed when placing a workload. For example, a server with a lower fan speed may be selected before a server with a higher fan speed.

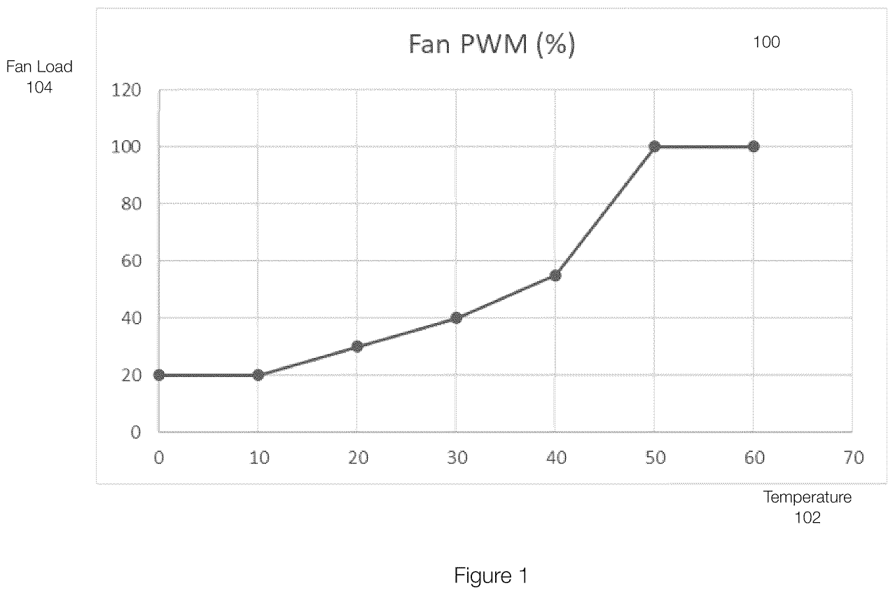

FIG. 1 discloses an example of a fan curve for a central processing unit, graphics processing unit, or other processor. The graph 100 illustrates that higher temperatures 102 are associated with a higher fan load 104. Fans can be optimized, in some examples, for low temperature, noise or the like or combinations thereof. In servers, fan curves are often optimized for low temperature and energy efficient operation. In one example, workloads are scheduled on servers that have the least thermal output and cooling load (e.g., fan speed (RPM) or PWM). Set points for the fan(s) may be included in settings of the server.

As the temperature of a machine or server increases, the cost has a corresponding increase. For example, more power may be required to operate the fan, hotter circuits May require more power, and other cooling systems may be engaged. In one example, the thermal load of a machine or of a data center can be reduced or minimized or managed by placing workloads in locations that are contributing less to the thermal load. For example, placing a workload on a machine with a lower temperature compared to a machine at a higher temperature may save power/cooling costs because the circuits are cooler and thus require less power and because the fan is operating at a lower fan load. Stated differently, workloads may be placed at servers with lower RPM or PWM because the corresponding temperature is likely lower.

In one example, a server is selected based on various constraints such as hardware, temperature, and fan speed. Other considerations such as geographical restrictions, power consumption type (e.g., renewable, non-renewable), power source, or the like may be included. Because servers differ in construction and capability, may have different fan set points, different power consumptions, and the like,

Selecting a server for scheduling a workload may be an optimization problem. However, heuristics or machine learning can be used to select a server. For example, a user could potentially enter a weighting for each variable and/or a threshold for how far the result of an equation or algorithm is allowed to be from an ideal number or target. An algorithm such as an expected value, average, weighted average, or the like, could be used in the creation of a ranking for which server would be best or meets the greatest number of required/desired characteristics. In one example, none or few of these values or characteristics would be outside of a predefined threshold. In another example, the output of the equation or algorithm would not be outside of a predefined threshold. Example machine learning may include neural networks, federated learning, transfer learning, reinforcement learning, or the like.

As discussed in more detail below, various data may be collected from servers or computing resources in the computing environment. This data, referred to herein as thermal data, may be used in by a scheduling engine to schedule workloads in a computing system (e.g., a data center, an edge data center, a micro data center, an on-premise system, or the like).

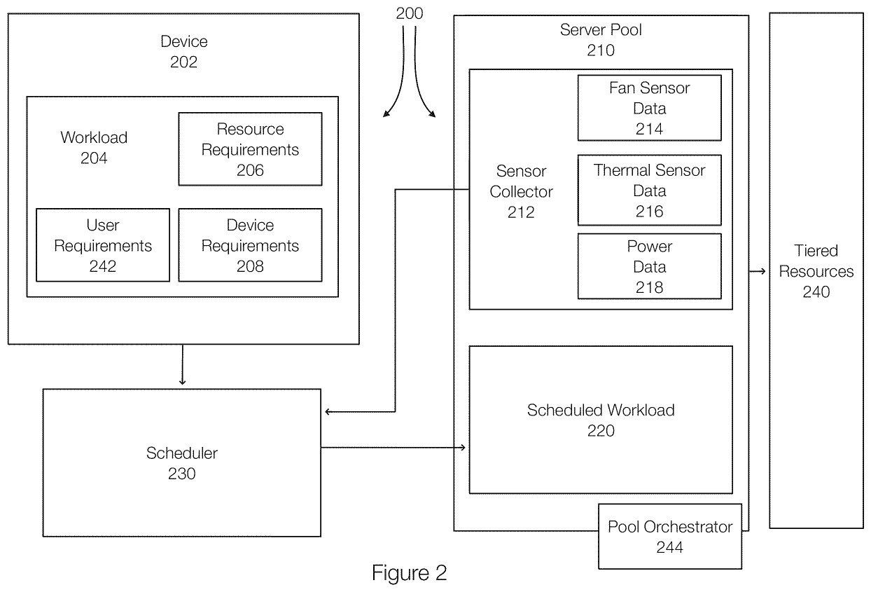

FIG. 2 discloses aspects of scheduling workloads in a thermally aware manner. The system 200 is an example of a computing environment (e.g., a server pool 210) that is configured to execute client workloads. In addition to scheduling workloads in a thermally aware manner, embodiments of the invention may also consider resource availability. If the optimal server, from a thermal perspective, does not have sufficient resources, this may cause, for example, a delay in execution. Embodiments of the invention may consider these and other aspects of the server pool 210 when scheduling workloads.

Generally, embodiments of the invention relate to a scheduling engine that includes a scheduler 230 and/or a sensor collector 212. The scheduler 230 typically receives workloads from users and based on requirements of the workloads, schedules the workloads to selected servers for execution. The scheduler 230 determines or selects a server (or servers) using thermal data received from the sensor collector 212. The sensor collector 212 collects sensor data from servers in a pool of servers (or other computing system). The collected data includes data from thermal sensors (e.g., all available thermal sensors), fan load, server current and/or peak power consumption. As discussed above, other data may be available for use by the scheduler 230 and can be obtained from the server pool 210 or from a pool orchestrator 244. The pool orchestrator 244 may provide information related to workload queue, expected execution times, resource availability, capacity, or the like.

The sensor collector 212, in one example, may interface with remote access card (RAC) APIs (Application Programming Interfaces) such as provided by a controller (e.g., iDRAC (integrated dell remote access controller)) or other controller. Alternatively, an agent may be installed in the servers that is configured to collect the sensor data and send or provide to the sensor collector 212 or, more specifically, to the scheduler 230.

Implementing the scheduler 230 may depend on the deployment stack. The scheduler may be implemented in a containerized environment, as a virtual entity, use remote procedure calls (RPC), remote agents, or shell agents.

More specifically, FIG. 2 illustrates a client or device 202 that is submitting a workload 204 for execution in the server pool 210, which is an example of a data center or is a portion of a data center in one embodiments. The workload 204 is associated with resource requirements 206 and device requirements 208. In this example, resource requirements 206 may refer to hardware/software requirements. The device requirements 208 may refer to geographic restrictions or the like. Workloads may be associated with other requirements and in some instances, these requirements 206 and 208 may only be partially provided.

The workload 204 may also be associated with user requirements 242. The user requirements 242 may specify user requirements such as expected (or required) completion time, start time, or the like. Examples of user requirements may include geographical location, power consumption type (e.g. renewable, non-renewable, solar, wind, etc.), vendor (e.g. in an edge or multi-cloud scenario), weightings for the importance of any requirement(s) in the scheduling process, or the like.

In this example, the scheduler 230 receives the workload 204 and the requirements 206, 208, 242. The scheduler 230 receives thermal data from a sensor collector 212. The thermal data may include, by way of example only, fan sensor data 214, thermal sensor data 216, and power data 218. More generally, the fan sensor data 214 may include fan curves for each server, which may include temperature and fan speed setpoints. The fan sensor data 216 may include simply a fan speed or PWM. The thermal sensor data 216 may include real-time temperature readings from temperature sensors or probes that control the fan curves. In one example, an exhaust probe is an example of a temperature sensor or probe that may control the fan curve. However, the temperature sensor or probe may be a CPU probe or other temperature sensor used to control the fan. For example, detecting an increase in the exhaust temperature may cause the fan curve to move the fan to the next set point (e.g., higher RPM or higher PWM).

The power data 218 may include energy consumption of the power supply level for the server chassis. This may include current, peak power, or other relevant metric. Energy consumption is an indicator of the expected thermal output of the server, heat spikes, and an amount of cooling needed for the chassis or for the server. The power data 218 may also identify the type of power (e.g., renewable, non-renewable).

The scheduler 230 evaluates the thermal data received from the sensor collector 212, the resource requirements 206, and the device requirements 208 and places the workload 204 in the server pool 210 as a scheduled workload 220.

In one example, the computing resources represented by the server pool 210 may be tiered. Thus, the server pool 210 may represent edge resources and the tiered resources 240 may represent multiple instances of additional (typically larger) resources. The computing resources can be scaled vertically (tiered) and horizontally (multiple edge groups—each providing a pool of servers). The scheduler 230 may be configured to schedule a workload in various resources that may be in different tiers, in different geographic locations, or the like. Embodiments of the invention may operate in various configurations and may be localized or distributed in organization. In addition, embodiments of the invention contemplate multiple schedulers 230. For example, in a system that includes edge computing resources and cloud computing resources, a first scheduler may be provided for edge computing resources and a second scheduler may be provided for the cloud computing resources. The schedulers may coordinate and this may further facilitate moving a load from one computing system to another computing system if the movement satisfies all relevant requirements and is thermally beneficial.

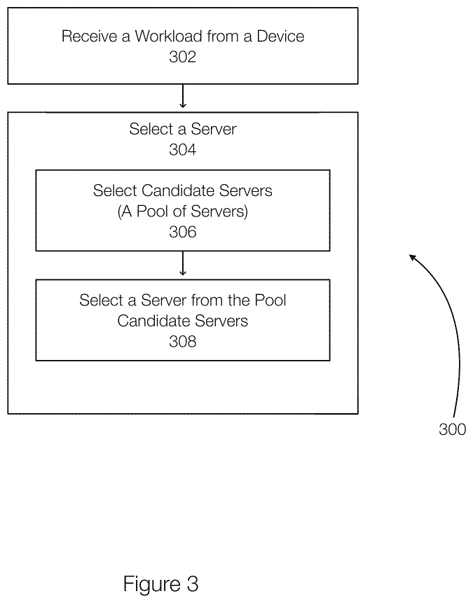

FIG. 3 discloses aspects of a method for scheduling a workload in a thermally aware manner. The method 300 includes receiving 302 a workload from a device. The workload may be created by a user operating at a device or in another manner. When generating the workload, requirements including resource requirements, device requirements, and/or user requirements may be specified. The workload may be received 302 at a scheduler, which may be part of a scheduling engine.

The scheduler may be configured to receive or collect thermal data from a computing environment, such as a pool of servers or other group of computing resources. The scheduler may also receive data an orchestrator such as server capacities or resource availability. For example, fan sensor data may include (e.g., for each device or server in the pool) a revolution per minute value, a PWM or duty cycle, a next fan setpoint (and associated temperature), or the like. Thermal sensors may provide data such as exhaust temperature, CPU temperature, ambient chassis temperature, or the like for each of the servers or devices. The power data may include current energy consumption (e.g., in watts), current, or other power value for each of the servers or devices.

More generally, the computing environment may be equipped with other sensors that may provide other measurements such as, power, voltage, or current data, and other data that may be used in evaluating thermal output. The thermal data may be aggregated, averaged, or the like. Thus, the thermal data may be evaluated in a manner that is specific to a server, to a set of servers (e.g., a rack of servers), a row of servers in the datacenter, or the like. This may allow embodiments of the invention to place workloads at different granularity (e.g., server level, rack level, row level). In one example, the thermal data is machine specific (e.g., a server computer or machine).

Embodiments of the invention apply to various scenarios. In addition to computing resources or systems in a cloud or datacenter, embodiments of the invention may also apply to edge scenarios. Thermal data can be device specific, cluster specific, group of cluster specific, or the like or combinations thereof. This may allow a workload to be scheduled, whether in a datacenter, edge, or other scenario, that can account for the thermal impact from a single device and/or from a different group perspective. For example, scheduling a workload to a group of clusters based on the thermal data of the cluster may have a smaller thermal impact that scheduling the workload to a specific machine based on the thermal data of the specific machine. This may allow the cooling impact of multiple fans or other cooling systems to be considered along with the cooling impact of a single fan.

Next, the scheduler may select a server or servers (when multiple servers are required) for scheduling the workload received from a client. The selection of a server may be performed in different manners. In one example, candidate servers are selected 306. Selecting candidate servers may include selecting candidate servers from a pool of servers. The servers included in the pool of candidate servers includes the that have the computing resources to schedule the workload. Servers that do not have the CPU, GPU, and/or other processor, memory or other requirements to schedule (e.g., execute) the workload may not be considered as candidate servers even if present in the larger pool of servers.

Next, a server in the pool of candidate servers is selected 308. The server selected from the pool of candidate servers has the lowest power consumption, current lowest temperature point, and/or lowest fan load in one example. This type of data (thermal data) is typically collected from the servers in the computing resources continually, periodically, on demand, on another schedule, or the like and provided to the scheduler.

As previously stated, the thermal data may represents constraints and evaluating the thermal data to select a server for scheduling the workload presents an optimization problem at least because the same server may not be the lowest in each of these characteristics. Other constraints, such as geographic constraints, may also need to be satisfied in selecting 308 the server for scheduling the workload from among the candidate servers. User requirements may also be considered when scheduling the workload

The optimization problem may be solved using heuristics (e.g., default to lowest fan speed, or lowest peak power). In another example, the optimization problem may be solved using machine learning. For example, historical data regarding workload scheduling, workload execution, fan speeds, fan PWM, available resources, energy consumption, changes in thermal output, thermal data, or the like may be collected and used to train a machine learning model configured to predict a best server for scheduling when inputting features such as thermal data.

Scheduling workloads to minimize cooling requirements produces a smaller thermal footprint for each workload added to the computing environment. This advantageously reduces energy requirements. The thermal data, such as fan curve or fan speed or PWM, may be used as input for scheduling a workload to a server with improved thermal consequences or output. Thus, embodiments of the invention may generate less heat (have a smaller thermal output or footprint) compared to other workload scheduling mechanisms.

If a workload is too large for a selected server or the server (servers) that receives the workload, the workload can be slowed, stopped, moved, delayed until resources are available, or the like. In one example, a workload (and/or its thermal impact) may grow over time as additional workloads are added to the same server or set of servers. If the thermal impact is being monitored, the thermal impact may be dynamically controlled by slowing a workload, moving the workload, stopping the workload, delaying the workload, or the like. Thus, managing or controlling the thermal impact of workloads is not limited to selecting a server, but also relate to ongoing workload execution.

If a workload is moved, a similar selection process may be performed to identify the next destination for the workload.

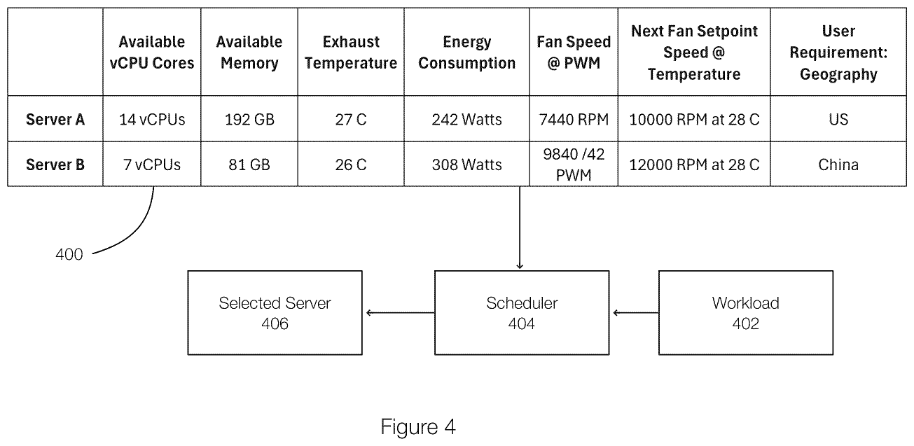

FIG. 4 discloses aspects of an example of selecting a server in a thermal aware manner. In FIG. 4, a scheduler 404 receives a workload 402 for scheduling. The requirements of workload 402 include 4 vCPUs, 32 GB memory, and a US location. No other hardware or IO requirements are specified in this example.

The scheduler 404 may also receive data 400 that may be used in for servers (e.g., server A and server B) in a pool of servers. In this example, part of the data 400 includes thermal data received from a sensor collector such as an exhaust temperature, energy consumption, fan speed, and next fan setpoint speed (with temperature). The cores and available memory included in the data 400 received or accessed by the scheduler 404 may be available from another source or may be provided by the sensor collector in one example. The geography portion of the data 400 identifies a location of the server and may have been received with the workload. Resource requirements may have also been received along with the workload.

In this example, a workload 402 is received and includes the following requirements: 4 vCPUs, 32 GB memory, US location. No other requirements were specified in this example. The scheduler 404 may select a server (from among Server A and Server B in this example) that has a current minimum temperature, a current lowest fan speed, and current lowest power consumption from the pool of servers. In this example, the best server is server A. Both servers A and B have the necessary hardware to schedule the workload, but Server A has the lower fan speed, lower fan speed setpoints, and lower power consumption. The server A also meets the user geographical requirement of being in the US. Even though the server A has a higher current exhaust temperature, server A is a better choice than Server B because this selection minimizes the other constraints.

Thus, one heuristic is to prioritize the characteristics. In one example, fan speed or PWM may be a first priority. In another example, a server with a plurality of best characteristics (e.g., lowest fan speed, lowest energy consumption) may be selected even when its exhaust temperature is higher. In some instances, it is also possible to specify whether the criteria or characteristics are optional or required in the user requirements. Further, the user requirements may specify whether a less-optimal solution is permissible, whether the workload should be delayed until a more optimal scheduling can be performed, or the like.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, thermal management operations, thermally aware workload placement operations, server selection operations, thermally based optimization selection operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform operations initiated by one or more clients or other elements of the operating environment. The storage environment may also be an edge environment or the like.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operations of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a workload for execution in computing resources that include a pool of servers at a scheduler, receiving thermal data from each of the servers in the pool of servers, at the scheduler, from a sensor collector, wherein the thermal data includes fan sensor data, selecting a server from the pool of servers based on the fan sensor data, and scheduling the workload to the selected server.

Embodiment 2. The method of embodiment 1, wherein the fan sensor data comprises a fan speed, a fan curve, fan setpoints, and/or a PWM value for each of the servers.

Embodiment 3. The method of embodiment 1 and/or 2, wherein the thermal data further comprises power data and thermal sensor data for each of the servers, wherein the power data includes a current or a peak power or a lowest power.

Embodiment 4. The method of embodiment 1, 2, and/or 3, wherein the thermal data comprises an exhaust temperature for each of the servers, a processor temperature, and/or other temperatures from other sensors.

Embodiment 5. The method of embodiment 1, 2, 3, and/or 4, wherein the selected server is selected by optimizing constraints represented by the thermal data.

Embodiment 6. The method of embodiment 1, 2, 3, 4, and/or 5, wherein the selected server is identified using a heuristic or a model that has been trained on historical thermal data and scheduling data.

Embodiment 7. The method of embodiment 1, 2, 3, 4, 5, and/or 6, further comprising receiving user requirements, resource requirements, and/or device requirements along with the workload.

Embodiment 8. The method of embodiment 1, 2, 3, 4, 5, 6, and/or 7, further comprising identifying candidate servers from the pool of servers, wherein candidate servers are those that have available resources to satisfy the resource requirements and/or the device requirements, wherein the resource or user requirements specify hardware and/or software requirements.

Embodiment 9. The method of embodiment 1, 2, 3, 4, 5, 6, 7, and/or 8, wherein the computing resources comprise tiered computing resources, wherein a workload that is too large for a selected server is moved to a server with larger resources.

Embodiment 10. The method of embodiment 1, 2, 3, 4, 5, 6, 7, 8, and/or 9, wherein scheduling the workload includes deploying the workload and executing the workload at the selected server.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

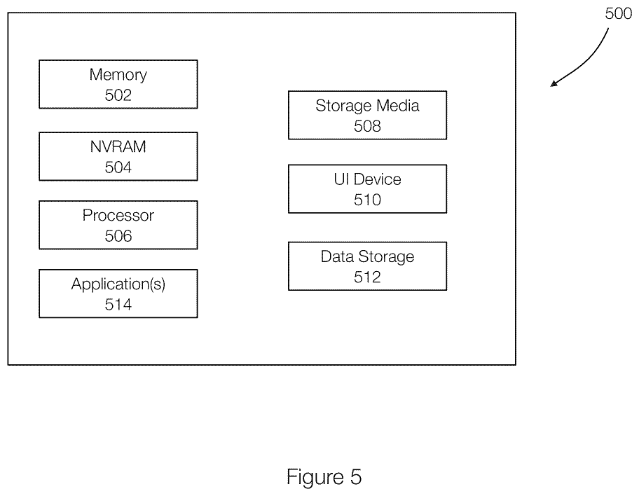

With reference briefly now to FIG. 5, any one or more of the entities disclosed, or implied the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
receiving a workload for execution in computing resources that include a pool of servers at a scheduler;
receiving thermal data from each of the servers in the pool of servers, at the scheduler, from a sensor collector, wherein the thermal data includes fan sensor data;
selecting a server from the pool of servers based on the fan sensor data; and
scheduling the workload to the selected server.

2. The method of claim 1, wherein the fan sensor data comprises a fan speed, a fan curve, fan setpoints, and/or a PWM value for each of the servers.

3. The method of claim 1, wherein the thermal data further comprises power data and thermal sensor data for each of the servers, wherein the power data includes a current or a peak power or a lowest power.

4. The method of claim 3, wherein the thermal data comprises an exhaust temperature for each of the servers, a processor temperature, and/or other temperatures from other sensors.

5. The method of claim 4, wherein the selected server is selected by optimizing constraints represented by the thermal data.

6. The method of claim 5, wherein the selected server is identified using a heuristic or a model that has been trained on historical thermal data and scheduling data.

7. The method of claim 1, further comprising receiving user requirements, resource requirements, and/or device requirements along with the workload.

8. The method of claim 7, further comprising identifying candidate servers from the pool of servers, wherein candidate servers are those that have available resources to satisfy the resource requirements and/or the device requirements, wherein the resource or user requirements specify hardware and/or software requirements.

9. The method of claim 7, wherein the computing resources comprise tiered computing resources, wherein a workload that is too large for a selected server is moved to a server with larger resources.

10. The method of claim 1, wherein scheduling the workload includes deploying the workload and executing the workload at the selected server.

11. A non-transitory storage medium having stored therein instructions that are executable by one or more hardware processors to perform operations comprising:
receiving a workload for execution in computing resources that include a pool of servers at a scheduler;
receiving thermal data from each of the servers in the pool of servers, at the scheduler, from a sensor collector, wherein the thermal data includes fan sensor data;
selecting a server from the pool of servers based on the fan sensor data; and
scheduling the workload to the selected server.

12. The non-transitory storage medium of claim 11, wherein the fan sensor data comprises a fan speed, a fan curve, fan setpoints, and/or a PWM value for each of the servers.

13. The non-transitory storage medium of claim 11, wherein the thermal data further comprises power data and thermal sensor data for each of the servers, wherein the power data includes a current or a peak power or a lowest power.

14. The non-transitory storage medium of claim 13, wherein the thermal data comprises an exhaust temperature for each of the servers, a processor temperature, and/or other temperatures from other sensors.

15. The non-transitory storage medium of claim 14, wherein the selected server is selected by optimizing constraints represented by the thermal data.

16. The non-transitory storage medium of claim 15, wherein the selected server is identified using a heuristic or a model that has been trained on historical thermal data and scheduling data.

17. The non-transitory storage medium of claim 11, further comprising receiving user requirements, resource requirements, and/or device requirements along with the workload.

18. The non-transitory storage medium of claim 17, further comprising identifying candidate servers from the pool of servers, wherein candidate servers are those that have available resources to satisfy the resource requirements and/or the device requirements, wherein the resource or the user requirements specify hardware and/or software requirements.

19. The non-transitory storage medium of claim 17, wherein the computing resources comprise tiered computing resources, wherein a workload that is too large for a selected server is moved to a server with larger resources.

20. The non-transitory storage medium of claim 11, wherein scheduling the workload includes deploying the workload and executing the workload at the selected server.
